(19) United States
(12) Patent Application Publication
(10) Pub. No.: US 2003/0052668 A1
(43) Pub. Date: Mar. 20, 2003

(54) Electronic speed measuring device for a beach buggy

(75) Inventors: Michael Yu, Tainan Hsien (TW); Tom Chen, Tainan Hsien (TW); Rad Sun, Tainan Hsien (TW)

Correspondence Address: BACON & THOMAS, PLLC, 625 SLATERS LANE, FOURTH FLOOR, ALEXANDRIA, VA, 22314

(73) Assignee: Aeon Motor Co., Ltd., Tainan Hsien (TW)

(21) Appl. No.: 09/955,176

(22) Filed: Sep. 19, 2001

(51) Int. Cl. G01P 3/48; G01P 3/54

(52) U.S. Cl. 324/174

(57) ABSTRACT

An electronic speed-measuring device for a beach buggy includes a magnetic member and a sensor. The magnetic member is fixed on the chain wheel driven by an engine of a beach buggy so the magnetic member rotates together with the chain wheel. The sensor is provided on an unmovable portion of a beach buggy, facing the moving track of the magnetic member and maintaining a proper distance from them. The sensor can detect the function of the magnetic member and transmit immediate digital data (signals) to a speedometer so that the speed of a beach bugay shown on the speedometer is extremely precise, achieving practical effect of installing with quickness and detecting speed with precision.

### BACKGROUND OF THE INVENTION

This invention relates to an electronic speed-measuring device for a beach buggy, particularly to one simple and convenient in installing and capable to detect the speed of a beach buggy precisely.

For the present, the speed-measuring device of a beach buggy is generally a mechanical one provided on one side of the axle. However, the way of installing such a speed-measuring device is always restricted by the axle, so it is generally provided by one-side pivotal connection, thus complicating installing and elevating its assembling cost.

### SUMMARY OF THE INVENTION

The objective of the invention is to offer an electronic speed-measuring device for a beach buggy, possible to be installed conveniently and having effect of precisely detecting the speed of a beach buggy.

### BRIEF DESCRIPTION OF DRAWINGS

This invention will be better understood by referring to the accompanying drawings, wherein:

FIG. 1 is a magnified cross-sectional view of the rear wheel of a beach buggy in the present invention:

FIG. 2 is a cross-sectional view of a detecting condition between a magnetic member and a sensor in the present invention:

FIG. 3 is another cross-sectional view of the detecting condition between the magnetic member and the sensor in the present invention.

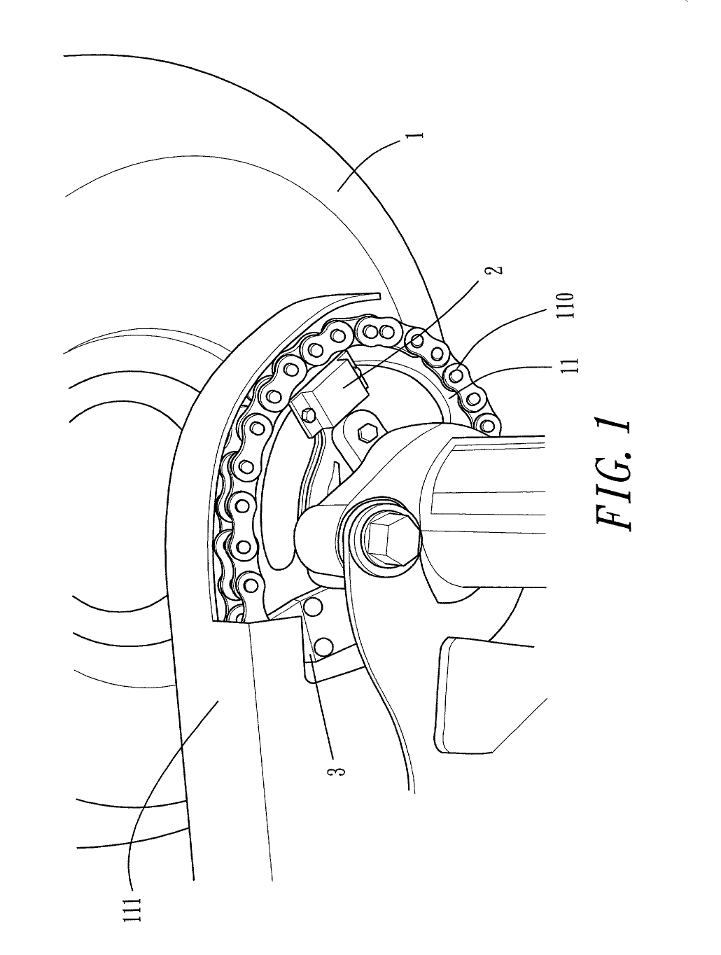

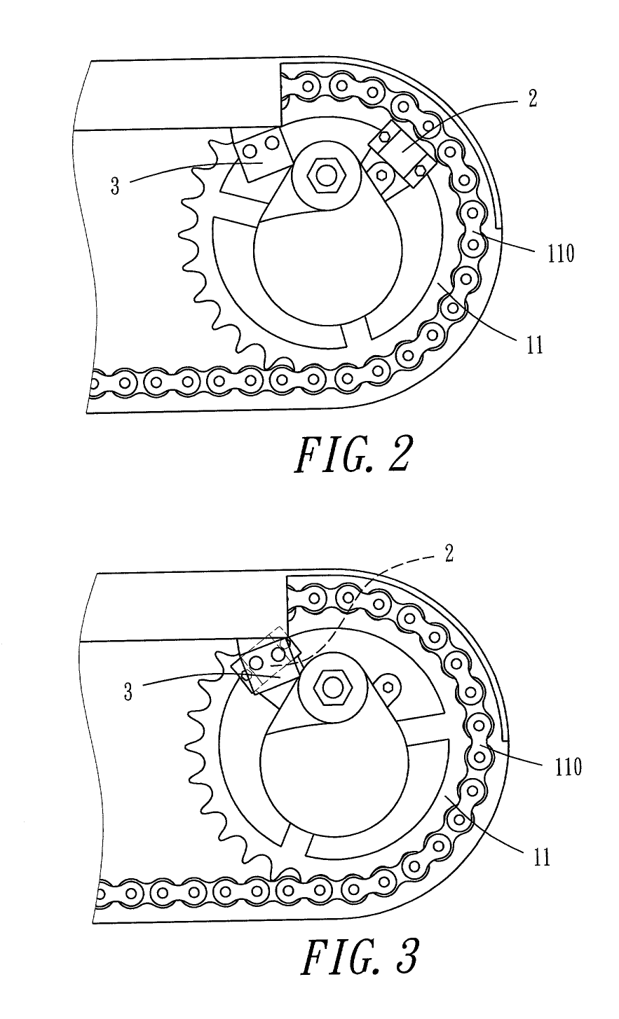

### DETAILED DESCRIPTION OF THE PREFERRED EMBODIMENT

A preferred embodiment of an electronic speed-measuring device for a beach buggy in the present invention includes a magnetic member 2 and a sensor 3 as main components combined together.

The magnetic member 2 (e.g. a loadstone) is fixedly provided on the chain wheel 11 fixed on an inner side of the rear wheel 1 of a beach buggy. A chain driven by an engine rotates the chain wheel 11 and the magnetic member 2 rotates together with the chain wheel 11.

The sensor 3 is fixed on an unmovable portion (such as a frame, a chain fender 111 or the like) of a beach buggy, with the sensor 3 facing the moving track of the magnetic member 3 and a proper distance set between the sensor 3 and the magnetic member 2, as shown in FIG. 3 so as not to make any friction and error between them. The sensor 3 can detect the function of the magnetic member 2, and immediate digital data (signals) produced is transmitted by the sensor 3 to a speedometer when the chain wheel 11 makes a full round rotation and the magnetic member 2 and the sensor 3 move in an overlapping condition. Therefore the speed shown on the speedometer is extremely precise.

As can be noted from the above description, this invention has the following advantages.

1. It can be installed on a beach buggy with quickness and is capable to detect the speed of a beach buggy with precision.

2. It completely improves the drawbacks of complicated assembling and easily causing errors of a conventional speed-measuring device.

While the preferred embodiment of the invention has been described above, it will be recognized and understood that various modifications may be made therein and the appended claims are intended to cover all such modifications that may fall within the spirit and scope of the invention.

I claim:

1. An electric speed-measuring device for a beach buggy comprising:
A magnetic member fixedly provided on a chain wheel rotated by a chain driven by an engine of a beach buggy, said magnetic member rotating together with said chain wheel:
A sensor provided on an unmovable portion of said beach buggy and facing a moving track of said magnetic member, having a proper distance between said sensor and said magnetic member, said sensor capable to detect the function of said magnetic member and transmit digital data (signals) to a speedometer so that said speedometer can precisely show the speed of said beach buggy.

2. The electronic speed-measuring device for a beach buggy as claimed in claim 1, wherein said magnetic member is a loadstone.
